(19) United States
(12) Patent Application Publication
(10) Pub. No.: US 2026/0149746 A1
(43) Pub. Date: May 28, 2026

(54) WIRELESS BED COMMUNICATION

(71) Applicant: Hatchmed Corporation, Seattle, WA (US)

(72) Inventors: Carl Cox, Kailua, HI (US); Jacob Glickstein, Seattle, WA (US); Kyrylo Keydanskyy, Seattle, WA (US); Brian Hatch, Seattle, WA (US)

(21) Appl. No.: 19/235,309

(22) Filed: Jun. 11, 2025

Related U.S. Application Data
(60) Provisional application No. 63/726,202, filed on Nov. 27, 2024.

(51) Int. Cl. H04L 67/12; H04W 76/14

(52) U.S. Cl. CPC H04L 67/12; H04W 76/14

(57) ABSTRACT

A method includes transmitting a first signal using a first protocol to a healthcare room-located device configured to communicate with a healthcare backend system. The method further includes receiving a pairing request from the healthcare room-located device that was transmitted responsive to the first signal. The method further includes responsive to the pairing request, establishing a wireless connection with the healthcare room-located device. The method further includes receiving a second signal from a healthcare facility bed. The method further includes responsive to receiving the second signal, transmitting a third signal using a second protocol to the healthcare room-located device.

### CROSS-REFERENCES TO RELATED APPLICATIONS

This application claims the benefit of and priority to U.S. Provisional Application No. 63/726,202, filed Nov. 27, 2024, and titled “WIRELESS BED COMMUNICATION,” the content of which is herein incorporated by reference in its entirety for all purposes.

### BACKGROUND OF THE INVENTION

A hospital bed can have functionality other than being used by a patient for laying down. To carry out the functionality, the bed may need to have a power and/or data connection.

Embodiments discussed herein address these and other issues.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

### BRIEF DESCRIPTION OF THE DRAWINGS

Various embodiments in accordance with the present disclosure will be described with reference to the drawings, in which:

FIG. 1 illustrates a block diagram of a system, according to certain embodiments of the present disclosure;

FIG. 2 illustrates a perspective view of a healthcare bed-mounted device, according to certain embodiments of the present disclosure;

FIG. 3 illustrates an alternative perspective view of a healthcare bed-mounted device, according to certain embodiments of the present disclosure;

FIG. 4 illustrates a perspective view of a healthcare room-located device, according to certain embodiments of the present disclosure;

FIG. 5 illustrates an alternative perspective view of a healthcare room-located device, according to certain embodiments of the present disclosure;

FIG. 6 illustrates an exemplary example of a method that may be performed by a healthcare bed mounted device, according to certain embodiments of the present disclosure;

FIG. 7 illustrates an example of a communication protocol from the perspective of a healthcare room-located device, according to certain embodiments of the present disclosure;

FIG. 8 illustrates a perspective view of a cable extender, according to certain embodiments of the present disclosure;

FIG. 9 illustrates an upright, alternative perspective view of a cable extender, according to certain embodiments of the present disclosure;

FIG. 10 shows a simplified diagram of a computer according to at least one embodiment.

### DETAILED DESCRIPTION OF THE INVENTION

In the following description, various embodiments of the present invention are described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

Embodiments of the present disclosure describe techniques for automatically carrying out communications between devices in close proximity to one another. For example, a bed may be rolled into a room and a device mounted on the bed may automatically connect to and carry out communication with another device (e.g., a wall mounted device) located in the room.

The present invention relates to a communication system for healthcare facilities that facilitates wireless interaction between a healthcare facility bed and room-located systems, such as nurse call systems. The system comprises a bed-mounted device (referred to herein as a “bed device”) and a room-located, often wall-mounted device (e.g., referred to herein as a room-located device) designed to establish a connection, enabling seamless communication of important signals like nurse calls and bed exit alarms. In specific embodiments, these connections can be wireless or wired.

The bed device can be attached to various types of healthcare facility beds using magnets, screws, adhesive, and/or other fasteners including using at least one of a magnet, a clip, a suction cup, a compression fitting, a hook or a loop fastener, providing flexibility and compatibility with existing bed models. The bed device may include one or more input/output ports (e.g., USB Type-C, 37-pin connectors, etc.) for power and data transmission and can be integrated or removably attached to the bed. The bed device may be capable of transmitting and receiving signals to and from a room-located device wirelessly using protocols such as Bluetooth Low Energy (BLE) and infrared (IR). The combination of wireless communication protocols may be useful because it can provide redundancy and increased reliability, allowing the bed device to maintain communication with the room-located device even if one protocol is temporarily unavailable or subject to interference. This approach may also enable plug-and-play operation across a wider variety of hospital environments and infrastructure, as the system can adapt to different connectivity requirements or physical layouts.

As an example, in certain embodiments, when a bed equipped with the bed device is brought into a room, the bed device periodically broadcasts a signal indicating its availability to pair. The healthcare room-located device detects the signal, and if not already paired with another bed device, initiates a pairing process to establish a wireless connection with the bed device. This connection can be maintained within a predetermined range (e.g., 4 feet, 25 feet, etc.). A status of the connection may be indicated by light emitting diode (LED) indicators on the healthcare room-located device changing from a first color of light to a second color of light. In certain embodiments, the LEDs may change from red (e.g., unpaired) to green (e.g., paired), providing immediate visual feedback to the healthcare facility staff.

Once paired, the bed device can transmit signals corresponding to nurse calls, bed exit alarms, or any other signals relevant for a healthcare context to the healthcare room-located device. For instance, when a nurse call button on the bed rail is pressed, the bed device can send data to the healthcare room-located device using both BLE and IR protocols for redundancy. The healthcare room-located device, in turn, may interface with a nurse call system (e.g., via a standard connector such as a 37-pin cable), triggering the appropriate alerts. The healthcare room-located device also supports keep-alive or heartbeat signals to maintain the connection and can automatically unpair when the bed is moved out of range or manually via a button on the healthcare room-located device.

The healthcare room-located device and bed device can be designed to be compatible with typical industry standards, allowing them to work with various bed brands and nurse call systems. Power can be supplied through internal or external batteries, nurse call systems, or external power supplies. Additional features include programmable LED lights on the healthcare room-located device for status indications, low battery indicators, and options for software updates via USB-C ports.

Certain embodiments described herein address the limitations of wired connections between beds and nurse call systems by providing a flexible, wireless solution. By providing reliable and redundant wireless communication, the system ensures critical alerts are promptly transmitted, reducing the risk of missed or delayed responses. The elimination of physical cables can reduce potential equipment damage around patient beds, lead to less material use, and result in longer times between replacement of components. The wireless design can simplify the process of setting up and removing beds, streamlining workflows, especially during high-pressure situations. Immediate visual feedback from LED indicators may allow for the assessment of system status without additional equipment checks.

The system's universal design may enable integration with a wide variety of existing hospital infrastructure, allowing compatibility with different brands of beds, nurse call systems, and facility layouts. This approach can facilitate plug-and-play deployment, as the system may be installed or retrofitted without requiring substantial modifications to existing equipment or wiring. For example, the healthcare facility bed device and the healthcare room-located device may be configured to recognize and adapt to differing interface standards, pin configurations, or communication protocols encountered in various healthcare settings. In some embodiments, this adaptability can be achieved by incorporating programmable logic, modular connectors, or software-defined interfaces that permit the system to automatically or semi-automatically detect and adjust to the connected bed or backend system.

Multiple attachment methods and adjustable placements for the devices may accommodate a range of room configurations and equipment models. The bed device may be attached using magnets, screws, adhesive pads, straps, brackets, or other fasteners, and can be positioned on various surfaces of the bed such as the side rails, headboard, footboard, or underneath the mattress platform. Similarly, the room-located device may be mounted on a wall, ceiling, headwall unit, or even mobile carts, using adjustable brackets, slide-on plates, or other mounting hardware. This flexibility can allow for rapid reconfiguration of patient rooms, easy upgrades, and the ability to deploy the system in both new construction and legacy hospital environments.

The system's user-friendly design, which may include intuitive status indicators such as LED lights, audible alarms, or touch-sensitive controls, can reduce training requirements for staff and minimize the risk of configuration and input error. Simple setup routines, such as automatic or one-touch pairing processes, may further streamline installation and day-to-day operation. In some embodiments, the devices may support over-the-air updates or configuration changes via standard ports (e.g., USB Type-C), enabling facilities to update firmware or adapt functionality without removing or disassembling the devices.

Flexible power options may be supported, such as battery operation, external power supplies, or power drawn from the bed or nurse call system. This flexibility can make installation straightforward in various settings, including situations where access to mains power is limited or where minimizing downtime during installation is important. In certain embodiments, power management features may allow the devices to operate for extended periods without battery replacement, further reducing maintenance overhead.

An additional benefit of the system may be enhanced communication reliability. For instance, in some embodiments, redundant communication via both Bluetooth Low Energy (BLE) and infrared (IR) protocols may be used to ensure that if one protocol encounters interference or is temporarily unavailable, the other protocol can maintain the communication link. This redundancy may be particularly advantageous in healthcare environments where wireless interference, line-of-sight obstructions, or physical barriers can sometimes disrupt signal transmission. The use of multiple communication channels may also facilitate rapid reconnection if a device is temporarily disconnected or moved, supporting continuous monitoring and event notification even as beds are relocated or rooms are reconfigured.

The overall plug-and-play capability of the system may reduce installation time, lower the risk of human error, and allow for rapid deployment in emergency or surge situations. The ability to quickly pair and unpair devices, automatically recognize bed types, and maintain reliable communication links can make the system highly adaptable to the changing needs of healthcare facilities. The system comprising the healthcare facility bed device and the healthcare room-located device may be referred to as “BlueJack™,” and may serve as a universal, interoperable platform for enhancing the safety, efficiency, and responsiveness of healthcare communication systems.

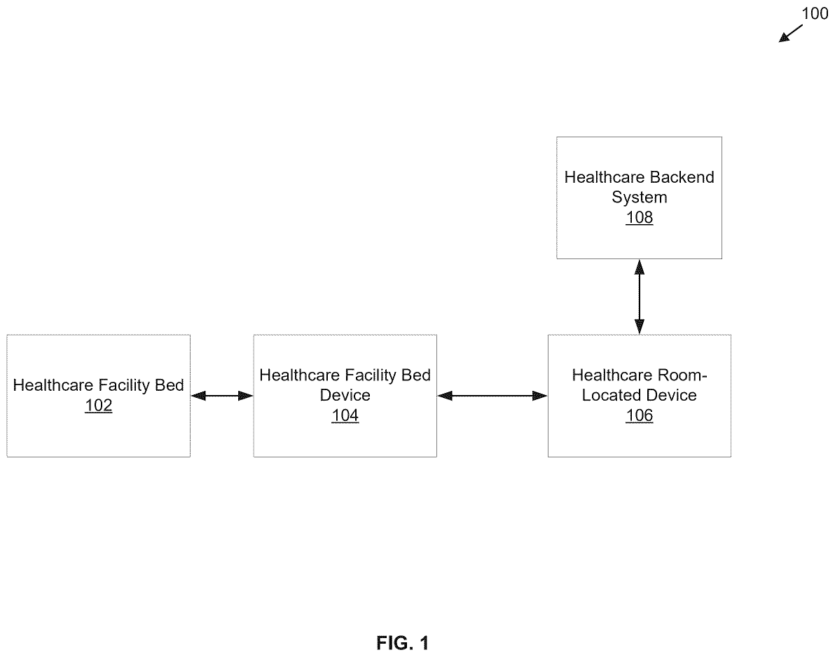

FIG. 1 illustrates a block diagram of a system 100, according to certain embodiments of the present disclosure. System 100 includes a healthcare facility bed 102, a healthcare facility bed device 104, a healthcare room-located device 106, and a healthcare backend system 108.

In the embodiments disclosed herein, transmissions can be light-based, radio-frequency based, or any other analogue or digital signal transmission known to persons of ordinary skill. For example, communication between system components may occur over a variety of wired or wireless data connections. Data connections can be established using wired interfaces such as quarter-inch connectors, multi-pin connectors (which may be proprietary designs or standardized connectors, such as 37-pin or USB), or other similar connectors. Wireless connections may include radio-frequency-based links, magnetic-based links, optical-based links, Bluetooth, Wi-Fi, infrared, or any suitable wireless protocol. These connections may operate across public or private networks, including local or wide area networks, and can also be configured as mesh networks to enhance reliability and coverage. In certain cases, a single connection may provide both data and power, including both physical cables and wireless connections such as with power-over-Ethernet or magnetic wireless charging. Components may be coupled through any combination of wired and wireless means, allowing the system to flexibly adapt to a range of hospital infrastructures and deployment scenarios. This comprehensive approach may facilitate plug-and-play installation, interoperability, and robust communication throughout the system.

The healthcare facility bed 102 may be a bed located in a healthcare facility such as a hospital, rehabilitation facility, skilled nursing facility, long-term care facility, outpatient clinic, emergency room, surgical suite, or any other setting where patient beds are used for clinical care, observation, or recovery. Healthcare facility bed 102 may be capable of communicating with other devices within the facility or broader network, either directly or through intermediary components. The healthcare facility bed 102 may also be capable of communicating with other devices. The healthcare facility bed 102 use wireless or wired communication to communicate with the other devices. The healthcare facility bed 102 may be equipped with sensors. Such sensors may include, for example, weight sensors to detect patient presence, pressure sensors to monitor patient movement or positioning, accelerometers or gyroscopes to detect bed angle or movement, and physiological sensors such as heart-rate monitors, pulse oximeters, respiratory rate sensors, or temperature probes. Controls on healthcare facility bed 102 may include nurse call buttons, bed exit alarms, brake status switches, bed height adjustment controls, patient safety rail sensors, or any other user interface elements designed to facilitate patient care and communication. The healthcare facility bed 102 can generate signals based on patient interactions, such as pressing the nurse call button or triggering a bed exit alarm.

The healthcare facility bed device 104 (hereinafter “bed device”) can be mounted on or integrated with the healthcare facility bed 102 (hereinafter “bed”). The bed device 104 may interface directly with the bed's sensors and controls, receiving input signals (e.g., nurse call activation, bed exit alerts) from the bed. These signals may be transmitted wirelessly in some embodiments. Bed device 104 may include one or more input/output ports, such as USB Type-C, mini-USB, proprietary connectors, 37-pin connectors, phono jacks, or other standard or custom interfaces, which can be used for power supply, data transmission, software updates, diagnostics, and/or connection to additional peripherals. Bed device 104 may be capable of transmitting and receiving signals to and from a room-located device 106 wirelessly, using one or multiple protocols such as Bluetooth Low Energy (BLE), infrared (IR), Wi-Fi, Zigbee, radio-frequency identification, near-field communication, or other wireless standards. In some embodiments, bed device 104 may support both wired and wireless communication, and may select the most appropriate protocol based on environmental conditions or user preferences.

A room-located device 106 may be positioned within a patient room or other relevant location in a healthcare facility, and can serve as an intermediary between bed device 104 and healthcare backend system 108. Room-located device 106 may be mounted on a wall, ceiling, headwall unit, or mobile cart, using adjustable brackets, slide-on plates, mating plates, or other mounting hardware, to accommodate various room configurations and optimal positioning for communication with bed device 104. Room-located device 106 may be configured to receive signals from bed device 104 wirelessly, using protocols such as BLE, IR, Wi-Fi, Zigbee, or other suitable communication standards, and may also support wired connections via multi-pin connectors, USB ports, Ethernet cables, or other interfaces. Room-located device 106 may include one or more input/output ports or connectors, such as 37-pin connectors, USB Type-C, or quarter-inch jacks, to facilitate integration with other hospital systems, external peripherals, or power supplies. Room-located device 106 may process incoming signals from bed device 104, such as nurse call activations or bed exit alarms, and relay these signals to healthcare backend system 108 via either a wired or wireless connection. Room-located device 106 may also send signals to bed device 104, such as pairing confirmations, configuration settings, or operational queries. User interface elements on room-located device 106 may include LED indicators, audible alarms, buttons, or touch-sensitive controls, which can provide visual and audible status feedback and allow healthcare staff to initiate or manage device functions. In some embodiments, room-located device 106 may support features such as over-the-air software updates, integration with third-party devices, or additional functionalities such as mass detectors, microphones, real-time location systems, or cameras.

The healthcare backend system 108 represents the healthcare facility's central monitoring or nurse call system. It processes incoming alerts and coordinates responses. The room-located device 106 can be connected to the healthcare backend system 108 via a wired interface, such as a standard 37-pin cable, and/or can be wirelessly connected to the healthcare backend system 108. Signals received from the bed device 104 can be transmitted to the healthcare backend system 108, triggering actions like activating nurse call alerts, logging events, or notifying healthcare staff. The healthcare backend system 108 can send signals to the room-located device 106, such as system acknowledgements, updates, or maintenance commands.

The healthcare facility bed 102 may be bidirectionally connected to bed device 104, which is configured to communicate with both the bed and other devices. The bed device 104 is bidirectionally connected to a healthcare room-located device 106. Finally, the healthcare room-located device 106 is bidirectionally connected to a healthcare backend system 108. When the healthcare facility bed 102 generates a signal (e.g., a nurse call), in certain embodiments, the bed device 104 receives this signal through a wired connection (e.g., via a 37-pin connector or USB Type-C port). The bed device 104 may process the incoming signal and prepares it for transmission to the room-located device 106. It may encode the signal using specific communication protocols. The bed device 104 can also receive signals from the healthcare room-located device 106 (hereinafter “room-located device,”) such as acknowledgement messages or configuration updates.

The room-located device 106 can be positioned within the patient room, and room-located device 106. The room-located device 106 can serve as a communication intermediary between the bed device 104 and the healthcare backend system 108 (hereinafter “backend system 108”). In certain embodiments, the connection between the bed device 104 and the room-located device 106 is established wirelessly using multiple protocols like Bluetooth Low Energy (BLE) with infrared (IR) for redundancy (e.g., a first protocol and a second protocol for redundancy, e.g., a first protocol and a second protocol for certain communications). In other embodiments, the connection can be performed by one wireless protocol alone. This connection may also be wired instead of wireless. The room-located device 106 receives signals transmitted wirelessly from the bed device 104, such as nurse call activations or bed exit alarms. The room-located device 106 can send signals, in certain embodiments, including a device identifier like a MAC address, to the bed device 104, such as pairing confirmations, configuration settings, or queries.

The following is an exemplary flow of transmissions between the various components of the system, in an embodiment. The bed device 104 periodically sends out a pairing request signal wirelessly using BLE and IR. The room-located device 106, if unpaired, receives this signal and sends back a pairing confirmation signal. The signals involved include a pairing request (upward) and a pairing confirmation (downward). A patient in a healthcare facility presses the nurse call button on the healthcare facility bed 102, generating a signal that may be sent to the bed device 104. The bed device 104 transmits this signal wirelessly to the room-located device 106 using both BLE and IR. The room-located device 106 relays the signal via the wired connection to the healthcare backend system 108. The healthcare backend system 108 processes the nurse call and dispatches appropriate alerts to the nursing staff. The signals involved in this process include a nurse call activation (upward from bed to backend system) and in certain embodiments, system acknowledgements (downward as needed).

If a bed exit alarm is triggered (e.g., the patient is attempting to leave the bed without assistance), the healthcare facility bed 102 may send this signal to the bed device 104. The bed device 104 sends the alarm signal to the room-located device 106. The room-located device 106 forwards the alarm to the healthcare backend system 108. Immediate action can then be taken by staff to ensure patient safety.

In some embodiments, the bed device 104 periodically sends heartbeat signals to the, room-located device 106 to maintain the connection. If the heartbeat signal is not received within a predetermined interval, the room-located device 106 can send a status update to the healthcare backend system 108 indicating a potential issue.

Both the bed device 104 and the room-located device 106 may have LED indicators. These indicators may show connection status, signal transmission status, and battery levels. The indicators corresponding to the room-located device 106 indicators may display pairing status (e.g., red for unpaired, green for paired), signal reception status, and error alerts.

The room-located device 106 may support communications with multiple bed devices 104. In this embodiment, signals from different beds are identified and routed appropriately to the healthcare backend system 108. Signals transmitted between devices can be encrypted to protect patient data. Furthermore, secure pairing processes can ensure that only authorized devices communicate.

In certain embodiments, remote updates can be supported. The healthcare backend system 108 can send firmware updates or configuration changes to the bed device 104 via the room-located device 106. In such embodiments, the signals involved include update packages (downward), and update confirmations (upward). Integration with Electronic Medical Records (EMR) can also be supported in embodiments of the present system. Data from the bed device 104 can be transmitted to the EMR system for automatic documentation.

In some embodiments, the system described herein can be connected to a broader bed management platform, enabling monitoring of bed presence and connection status. By interfacing with such a platform, a bed device 104, and/or a healthcare room-located device 106 can provide real-time data on bed occupancy, availability, and/or location within the facility.

Furthermore, several embodiments described herein can utilize manufacturer-provided safe bed monitoring features related to bed parameters such as brake engagement, bed height, and other safety statuses. These parameters can be communicated to devices like nurse phones, hall monitors, or centralized monitoring systems. For instance, if the bed's brakes are not engaged or the bed is not set at the appropriate height, a bed device (e.g., bed device 104) can send notifications through a healthcare room-located device (e.g., healthcare room-located device 106) to alert users.

The bed device 104 may include functionality to charge phones or personal devices. By incorporating a USB port or wireless charging capabilities through ports like the proximal I/O port 212 or the distal I/O port 302, the bed device can serve as a convenient charging station for patients or healthcare providers.

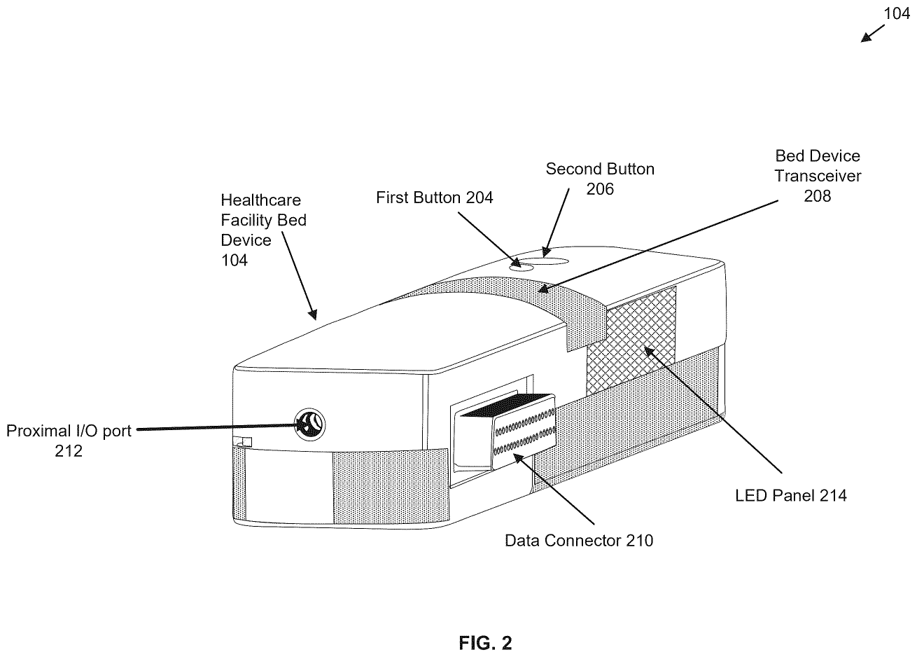

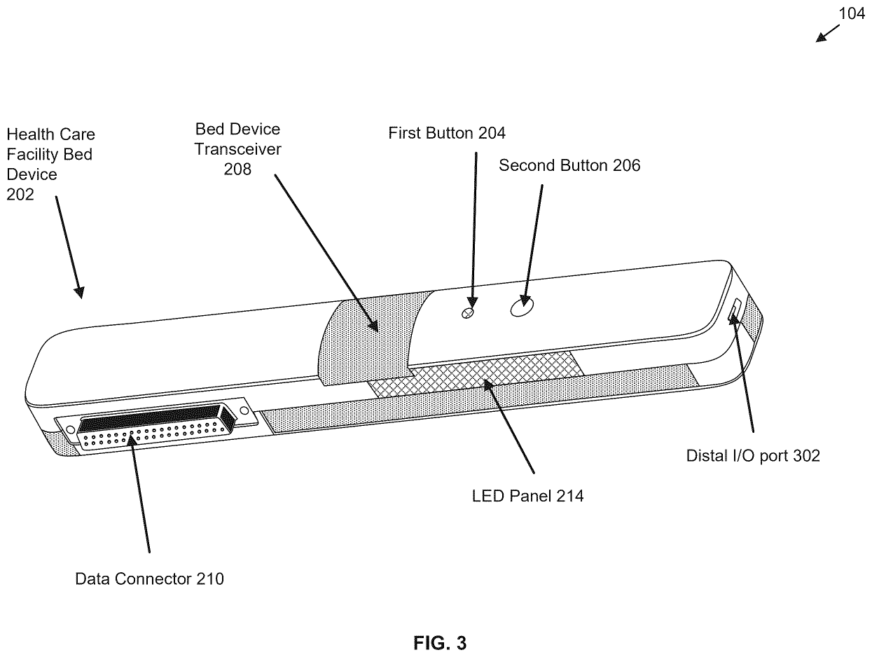

FIG. 2 illustrates a perspective view of a bed device 104, according to certain embodiments of the present disclosure. FIG. 3 illustrates an alternative perspective view of a bed device 104, according to certain embodiments of the present disclosure.

The bed device 104 may be mounted to the healthcare facility bed (e.g., the healthcare facility bed 102, described above with respect to FIG. 1). The bed device 104 may include any number of buttons, for example, a first button 204 and a second button 206. In certain embodiments, the first button 204 being pressed can cause initiating the pairing process with a room-located device (e.g., room-located device 106 described above) or resetting the bed device 104 when necessary. In certain embodiments, both first button 204 and second button 206 can be switched in purpose, or utilized in other roles and functions. For example, either first button 204 or second button 206 may be programmed to serve as a test button to verify device operation, or to activate and deactivate specific features such as a mute function, a local status indicator, or a pairing lockout mode. In some embodiments, pressing and holding one of the first button 204 or second button 206 may enter a configuration or programming mode, adjust device parameters, reset network settings, or initiate a firmware update. Either button may also be assigned to temporarily disable alarms, clear error states, cycle through battery status displays, or toggle between wired and wireless communication modes if both are available. The first button 204 and second button 206 may be configured to support multi-functionality through different press patterns, such as single press, double press, or long press, with each pattern mapped to a different action. In certain embodiments, the functions of first button 204 and second button 206 may be reprogrammable via a connected user interface or remotely through a backend management system, permitting customization based on the specific operational procedures or preferences of a healthcare facility. This flexibility in button assignment and usage may allow the bed device 104 to be adapted to a variety of workflows, user roles, and integration requirements.

A bed device transceiver 208 may be located on the top of the bed device 104, or elsewhere in some embodiments. The transceiver may be responsible for wireless communication using protocols like Bluetooth Low Energy (BLE) and Infrared (IR). It can enable the bed device 104 to both transmit and receive signals to and from devices (e.g., the room-located device 106 described above), ensuring that vital information such as nurse call activations and bed exit alarms are reliably communicated. In certain embodiments, the transceiver may not be used due to there being a wired coupling between the bed device 104 and the room-located device. The bed device 104 may receive the signals using a receiver (e.g., infrared (IR) receiver) external to the bed device 104 but wired or wirelessly coupled to the bed device 104. Such an external configuration may be used when the bed device 104 is otherwise obstructed, making a certain signal or type of communication protocol otherwise impractical.

In certain embodiments, self-pairing is initiated with the IR signal from the bed device 104. The address sent for pairing may be a MAC address or another unique identifier (e.g., MAC address for a device connected to the bed device 104, the bed device 104 itself, the healthcare facility bed 102, a microprocessor, etc.).

A data connector 210, which could be a pins connector like a 37-pin connector, may be situated on the top of the device (or elsewhere on the device). This connector functions as a direct interface for data exchange with the bed's internal systems. Through this connection, the bed device 104 can receive inputs from the bed, including signals from nurse call buttons and bed occupancy sensors, allowing it to monitor patient activity effectively.

In some embodiments, a part of the user interface is the LED panel 214, that may be located on the top of the device. The LED panel 214 provides visual indicators of the device's status, such as power levels, connectivity status with the room-located device, and active alarms. By offering immediate feedback, the LED panel 214 may allow a user to assess the operational state of the bed device 104, thereby enhancing response times and overall patient care.

The proximal I/O port 212 may be located on a side of the bed device 104, which serves as an input/output interface for connecting additional peripherals or power sources. This port can support various connectors, including USB Type-C, facilitating both data transfer and power supply options. A distal I/O port 302 (shown in FIG. 3) can provide further connectivity options for external devices or sensors. The inclusion of both I/O ports enhances the flexibility of the bed device 104, allowing it to integrate seamlessly with a wide range of systems and accommodate future technological advancements. In certain embodiments, the placement of these I/O ports may be different than is shown in FIG. 2, and they may be placed anywhere on the device.

The arrangement and functionality of these components may enable the bed device 104 to interface with a healthcare facility bed, other systems, and/or a healthcare backend system (e.g., healthcare backend system 108). In certain embodiments, the bed device 104 collects data from the healthcare facility bed 102, processes it, and communicates wirelessly with the healthcare room-located device through the bed device transceiver 208. The first button 204 and second button 206, along with the LED panel 214, facilitate user interaction by allowing users to control device functions and receive real-time status updates. Moreover, the proximal I/O ports 212 and the distal I/O port 302 can offer adaptable connectivity and power management solutions, ensuring the bed device 104 remains operational under various conditions and healthcare facility setups.

Potential uses and embodiments of the bed device 104 can include alternative attachment methods to the bed, such as using magnets, screws, or adhesive fasteners. This flexibility can enable the bed device 104 to be compatible with a variety of bed models and configurations. In situations where the bed device 104 line of sight is obstructed, an external IR receiver can be connected via the I/O Ports, enhancing the device's adaptability in different room layouts. The bed device 104 may be included in a housing of a bed (e.g., healthcare facility bed 102).

The first button 204, second button 206, and LED panel 214 of the bed device 104 can be programmable, allowing for additional functionalities to be added or customized according to specific healthcare facility needs. Software updates can be applied through the data connector 210, proximal I/O ports 212 or the distal I/O port 302. Other embodiments may incorporate other communication protocols and advanced security features, such as encryption and secure pairing methods, to protect patient data and maintain compliance with healthcare regulations. The bed device 104 can be powered through internal batteries, external power supplies, and/or by drawing power from a bed's electrical systems.

The bed device 104 may be designed for versatile attachment options and can be mounted on various surfaces of a healthcare facility bed (e.g., healthcare facility bed 102), such as the back area or underneath the healthcare facility bed. This flexibility can enable the bed device 104 to be positioned to minimize obstructions and maximize communication efficiency with the healthcare room-located device. In certain embodiments. the connection distance of the bed device 104 can be adjusted. The adjustment may be enabled by a first user interface (e.g., a button, a dial, and/or a touchscreen, etc.) of the bed device 104 and/or a second user interface of a different device (e.g., a mobile phone, a tablet, etc.). In some embodiments, the connection distances can be configured and overwritten by system update. In other embodiments, they may be physically adjustable on the bed device 104.

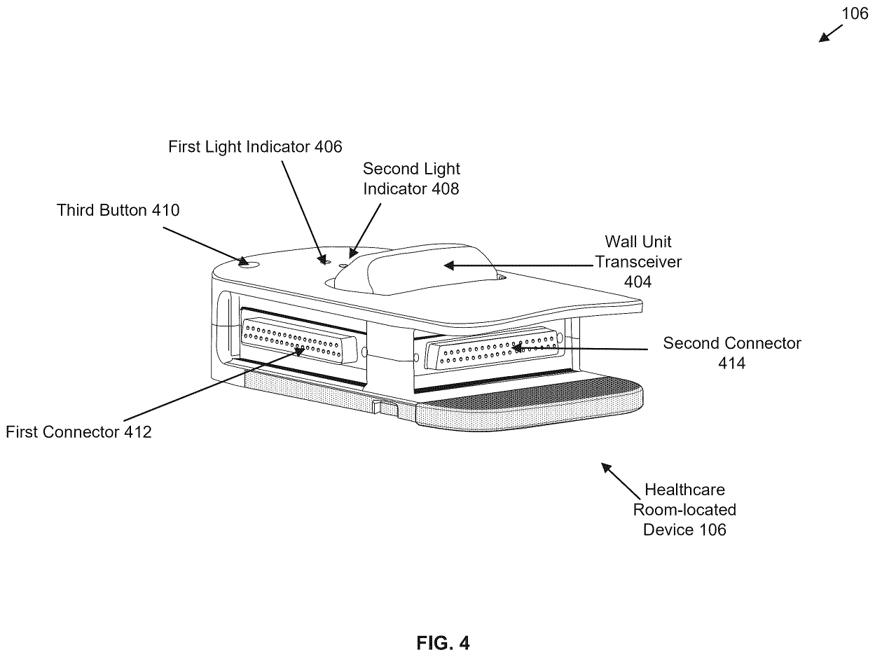

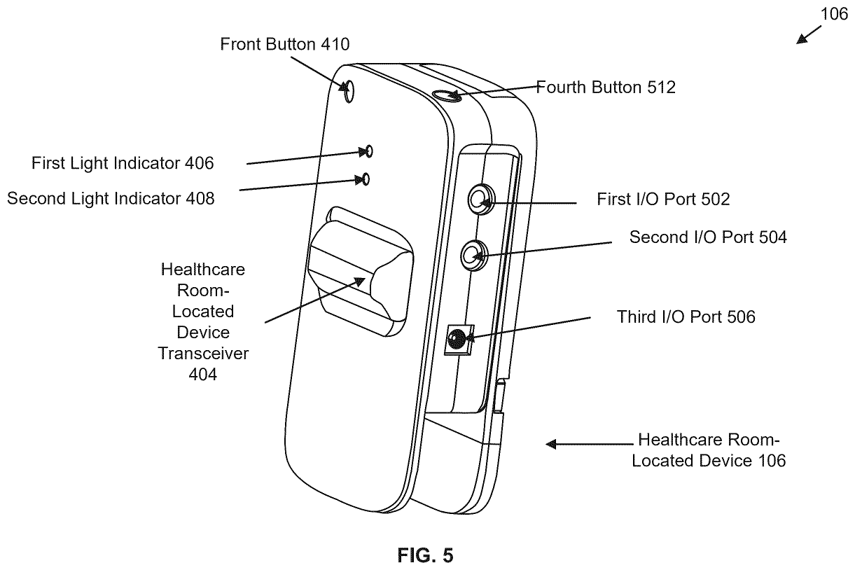

FIG. 4 illustrates a perspective view of a healthcare room-located device 106 (e.g., the healthcare room-located device 106 described above with respect to FIG. 1), according to certain embodiments of the present disclosure. FIG. 5 illustrates a second perspective view of the healthcare room-located device 106. Illustrated on the front of the room-located device 106, there are two indicators: the first light indicator 406 and the second light indicator 408. The first light indicator 406 and/or the second light indicator 408 may be located on other side(s) of the room-located device 106. These indicators can provide visual feedback to healthcare staff regarding the device's operational status, such as power levels, connectivity, and active alarms. A healthcare room-located device transceiver 404 of the healthcare room-located device 106 may facilitate wireless communication with a bed device (e.g., bed device 104) by transmitting and receiving signals using protocols like Bluetooth Low Energy and infrared, may be located on the front (or elsewhere) of the room-located device 106. In certain embodiments, the healthcare room-located device transceiver 404 may be cone-shaped to improve the range of the device, but may have other shapes in alternative embodiments. The healthcare room-located device 106 may include a third button 410, which may allow performing functions like initiating pairing processes, resetting the device, or canceling calls. The third button 410 may be located on any side of the healthcare room-located device 106.

An audible alarm or buzzer can be embedded within either the bed device 104 or the room-located device 106. This feature provides immediate audible notifications in response to specific events, such as a bed exit alarm or a nurse call. The inclusion of an audible alarm complements visual indicators like LED panels (e.g., LED panels 214) and a light indicator (e.g., first light indicator 406).

A fourth button 512 may serve additional control functions, such as unpairing the device, adjusting settings, or toggling operational modes. Input/output ports (e.g., first I/O port 502, second I/O port 504, and third I/O port 506) may provide connectivity options for external peripherals, power supplies, and/or integration with other healthcare systems. In certain embodiments, they can support various connectors, such as USB Type-C or quarter-inch jacks, facilitating data transmission and power management.

A first connector 412 and/or a second connector 414 are shown in FIG. 4 as 37-pin connectors but could be other types of connectors as well. These connectors may enable wired communication with a healthcare backend system (e.g., healthcare backend system 108) and/or other devices. They enable the room-located device 106 to interface directly with nurse call systems via standard connectors, transmitting critical alerts like nurse calls and bed exit alarms.

The healthcare room-located device transceiver 404 may allow the room-located device 106 to establish a wireless connection with the bed device to receive signals transmitted by the bed device. The first light indicator 406 and second light indicator 408 may provide visual indications of the device's status, such as pairing confirmation (e.g., turning green when paired or red when unpaired) and battery levels. In some embodiments the first light indicator 406 and second light indicator 408 are locally programmable to blink and change colors to match the needs of the healthcare facility. The third button 410 and fourth button 512 may enable additional functionality. For instance, pressing the third button 410 might initiate a manual pairing process or reset the device, while the fourth button 512 could be used to unpair the device or perform other operational functions.

The first I/O port 502, second I/O port 504, and/or third I/O port 506 can expand the healthcare room-located device 106 connectivity, allowing it to integrate with additional peripherals or accommodate various power options. For example, an external infrared receiver could be connected via these ports if the healthcare room-located device 106 placement obstructs line-of-sight communication. The ports may also support software updates or configuration changes, ensuring the healthcare room-located device 106 can adapt to future technological advancements or facility requirements.

The first connector 412 and the second connector 414 can provide reliable wired connections to the nurse call system or other backend systems. In certain embodiments, using standard 37-pin connectors ensures compatibility with a wide range of existing equipment, simplifying installation and integration. These connectors may facilitate the transmission of critical alerts to the healthcare backend system, triggering appropriate responses from staff and supporting patient safety. In alternative embodiments, the first connector 412 and the second connector 414 could be other types of connectors than those depicted.

In relation to the overall processes described in the patent application, in certain embodiments the healthcare room-located device 106 serves as an intermediary between the bed device and the healthcare backend system. In many embodiments, the healthcare room-located device 106 receives signals wirelessly from the bed device via the healthcare room-located device transceiver 404, processes the signals, and then communicates with the backend system through the first connector 412 and/or second connector 414. The healthcare room-located device 106 design can enable redundancy and reliability in communication by supporting both wireless and/or wired interfaces. While certain embodiments of the system utilizes protocols such as Bluetooth Low Energy (BLE) for wireless communication, it may be, additionally or alternatively, adaptable to other technologies, such as Thread, Bluetooth, NFC, Swift Pair, Wi-Fi device pairing, NB-IoT and GPRS device pairing, Wired device pairing, Gateway sub-device pairing, and Bluetooth mesh pairing and/or other pairing technologies.

In certain embodiments, the healthcare room-located device 106 can present (e.g., via speaker, via light, via display, etc.) the following information: the healthcare facility bed (e.g., healthcare facility bed 102) is connected; the healthcare facility bed is disconnected; the healthcare facility bed 102 alarm going off; low battery of any associated peripheral, including the healthcare room-located device 106, the bed device or the healthcare facility bed; the healthcare facility bed not in low height; the healthcare facility bed having brakes off/on; and a nurse presence in the room, etc. In some embodiments, two healthcare facility beds having two bed devices can be controlled by a single healthcare room-located device 106 and split lights (left and right) on the unit signals control of two healthcare facility beds.

In certain embodiments, the healthcare room-located device 106 and/or bed device can have a low battery indicator. The healthcare room-located device 106 can include a light that is photosensitive and tunable for dark or lighted rooms. In certain embodiments, the healthcare room-located device 106 may include a slide-off feature for installation, such as a mating plate, which facilitates easy mounting and dismounting of the device. This design can allow for flexible placement within the patient room, accommodating various wall configurations and ensuring optimal positioning for wireless communication with the bed device.

The healthcare room-located device 106 can also display information from third-party devices or beds that are connected to server-based systems. By pulling in server-based bed connectivity statuses, the healthcare room-located device 106 may provide real-time updates on bed availability, occupancy, and other pertinent data, which can be useful for hospital management and patient care coordination. Furthermore, the healthcare room-located device 106 may be capable of connecting to server-based systems, effectively integrating local device statuses into cloud-based platforms. This connectivity may enable remote monitoring, data analytics, and integration with electronic medical records (EMR), artificial intelligence (AI), or parameter-based call priority systems is supported, allowing for advanced functionalities such as recognizing and annunciating fall risks or other critical patient conditions.

An external sensor, can operatively be provided for the bed device or the healthcare room-located device 106 to enhance signal reception and transmission, in situations where direct line-of-sight is obstructed.

The bed connection status light on the healthcare room-located device 106, such as the first light indicator 406, can be designed as an external light or embedded within the product's housing. This visual indicator may provide real-time information about the bed's connection status to the system, allowing staff to quickly identify and address any connectivity issues. The use of multi-color LEDs enables more nuanced status indications beyond simple connected or disconnected states.

A reset button may be included on the healthcare room-located device 106, such as the third button 410 or fourth button 512, or on the bed device (104 in FIG. 1). This feature allows healthcare staff to easily reset the device in the event of a malfunction or when re-establishing a connection is necessary. An impact alarm can be implemented to send an alert if the bed device 104 falls to the floor.

In some embodiments the healthcare room-located device 106 can accommodate additional inputs and outputs to other nurse call devices. By providing extra ports like the first I/O port 502, second I/O port 504, and third I/O port 506, the system can integrate with a wider range of equipment, such as additional sensors or monitoring devices. Similarly, the bed device 104 can be equipped with additional 37-pin connectors, in certain embodiments two or more, or other nurse call or phono jack connections. These connectors, such as the proximal I/O port 212 and distal I/O port 302, allow for greater integration with various bed models and accessories. The bed device 104 or healthcare room-located device 106 can also be used to charge personal devices.

In other embodiments, the healthcare room-located device 106 may be equipped with additional features such as a mass detector, microphone, real-time location system (RTLS), or camera. These components enhance the system's ability to monitor the presence and movement of individuals within the room, detect if a patient has fallen, and provide additional security and monitoring capabilities. Integration with systems like RTLS allows for precise tracking of equipment and personnel.

In alternative embodiments, light projections can be implemented inside or outside the patient room to indicate the safe or unsafe status of the bed. For example, the healthcare room-located device 106 can project symbols or color-coded lights onto walls or floors to signal to staff whether the bed's safety features, such as brakes or bed height, are properly set.

In some embodiments, the healthcare room-located device 106, can connect through a hardwired connection to certain beds to pull and distribute bed monitoring parameters. By accessing detailed bed data such as patient weight, movement, or vital signs, the system can integrate this information into centralized monitoring systems or electronic health records (EHR). Bed safety notices can be distributed across various platforms, including monitoring systems, administrative portals, staff phones, dome lights, hall monitors, projectors, or audible alarms.

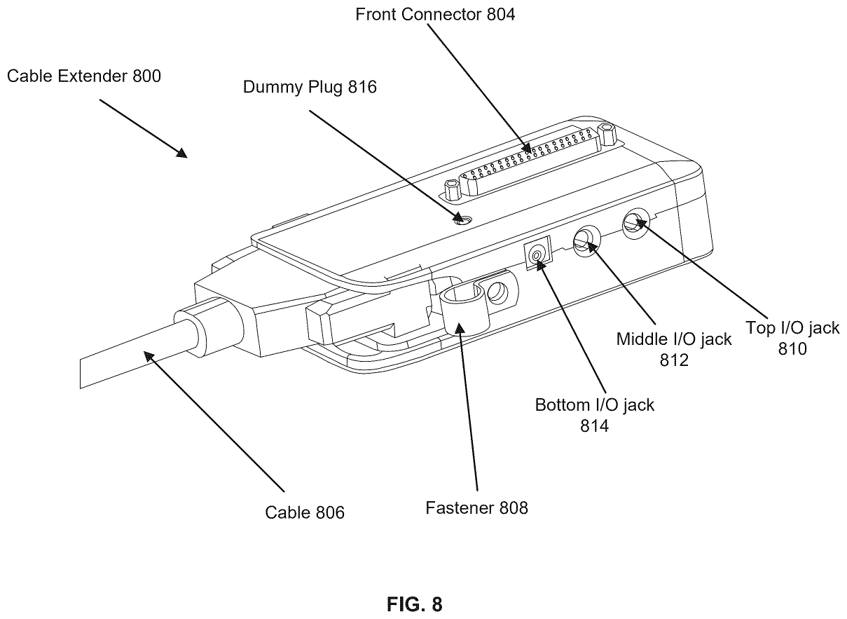

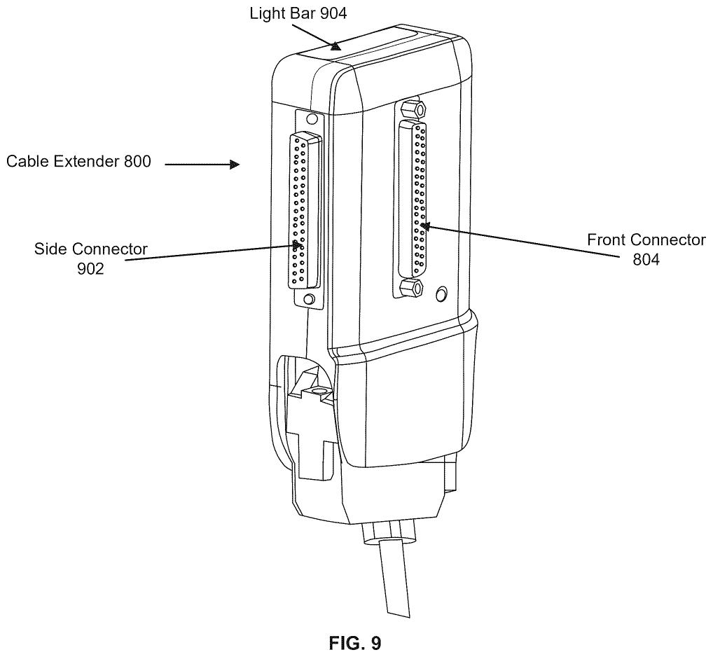

In certain embodiments, the system allows for communication from server-connected beds or devices to the nurse call system via the healthcare room-located device 106, such as the cable extender 800 depicted in FIGS. 8 and 9. This configuration requires a universal hub operatively connected to the server-connected device, which may be integrated into any of the bed device 104, the room located device 106, or the healthcare backend system 108, described above.

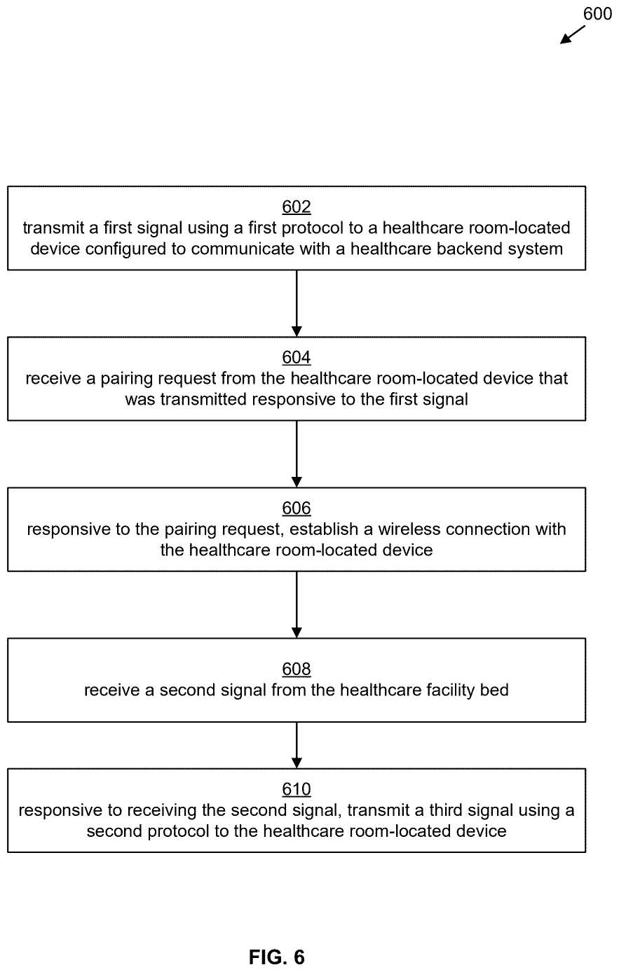

FIG. 6 illustrates an exemplary example of a method 600 that may be performed by a healthcare bed mounted device (e.g., the bed device 104 described above with respect to FIG. 1), according to certain embodiments of the present disclosure.

At step 602, the bed-mounted device initiates communication by transmitting a first signal to a healthcare room-located device (e.g., healthcare room-located device 106). This signal may be sent using a first wireless communication protocol, such as Bluetooth Low Energy (BLE) or infrared (IR). The purpose of this signal can be to announce the presence of the bed-mounted device and indicate that it is available to establish a connection. By periodically broadcasting this signal, the bed-mounted device, when brought into a patient room, can begin a pairing process with the room-located device without manual intervention.

At step 604, in response to the first signal, the healthcare room-located device can send back a pairing request to the bed-mounted device. In certain embodiments, this pairing request is received using the same first wireless communication protocol. In some embodiments, the pairing request signifies that the room-located device has detected the bed-mounted device and is ready to establish a secure wireless connection. The bed-mounted device may process this request to authenticate and confirm the initiation of the pairing process.

At step 606, responsive to receiving the pairing request, the bed-mounted device may establishing a wireless connection with the healthcare room-located device. In certain embodiments, this may involve a handshake process where both devices exchange necessary credentials and agree upon communication parameters. In alternative embodiments, security measures such as encryption keys may be exchanged to ensure that the connection is secure and that patient data is protected. In other embodiments, once the connection is established, both devices can communicate bidirectionally.

At step 608, a second signal may be received from the healthcare facility bed. The bed-mounted device may monitor/listen for a signal from the healthcare facility bed. The second signal may originate from the bed's integrated systems, such as a nurse call button activation, a bed exit alarm, and/or other patient-monitoring sensors. This second signal may be received via a wired and/or wireless connection between the bed and the bed-mounted device, using interfaces like a data connector or input/output ports. The bed-mounted device can interpret this second signal as an event that requires action or notification.

At step 610, in response to receiving the second signal from the bed, the bed-mounted device may transmit a third signal to the healthcare room-located device. This third signal can be sent using a second protocol, which may differ from the first protocol used during the initial connection. For instance, if the first protocol was BLE, the second protocol might be IR, or vice versa. The use of a different protocol for this transmission can provide redundancy and/or increase the reliability of critical communications.

The third signal can convey specific information about the event detected by the bed-mounted device, such as a patient pressing the nurse call button or triggering a bed exit alarm. By transmitting this signal promptly, the bed-mounted device ensures that the healthcare room-located device receives timely notifications to relay to the healthcare backend system.

The use of both a first and a second protocol for communication may provide a fail-safe mechanism. If one protocol encounters interference or fails, the other can ensure that vital signals are still transmitted successfully. During the establishment of the wireless connection in 606, security protocols such as encryption and authentication can be implemented to protect patient data and prevent unauthorized access to the communication system. The bed-mounted device and the room-located device may be designed to pair automatically when the bed enters the room and unpair when the bed is moved away. This automatic process reduces the need for manual setup and helps prevent errors. Both devices may include LED indicators to provide visual feedback on the connection status, battery levels, and signal transmissions. For example, LEDs might turn green when successfully paired or red when unpaired, assisting staff in quickly assessing device status.

The bed-mounted device may periodically send heartbeat or keep-alive signals to maintain the connection with the room-located device. If these signals are not received within a predetermined timeframe, the devices may automatically unpair, or a notification may be sent to another device or system to indicate a potential issue. While BLE and IR are common protocols mentioned, the system is designed to be adaptable to other wireless communication standards, such as Wi-Fi, Zigbee, or future protocols optimized for healthcare environments.

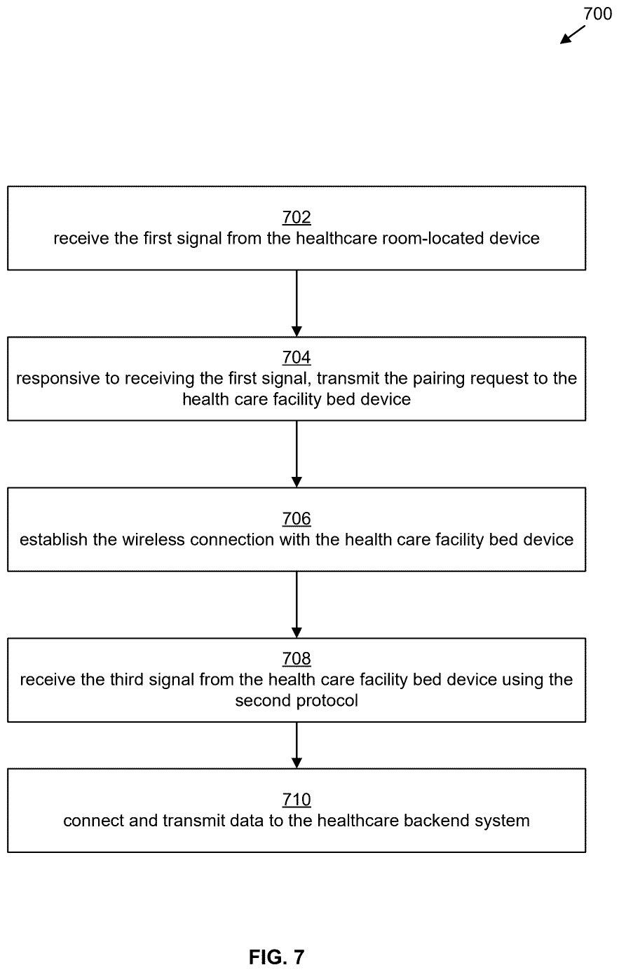

FIG. 7 illustrates an example of a communication protocol from the perspective of a healthcare room-located device (e.g., the healthcare room-located device 106 described above), according to certain embodiments of the present disclosure.

At step 702, The healthcare room-located device may begin the communication protocol by receiving a first signal from the healthcare bed-mounted device. This initial signal may be transmitted using a first wireless communication protocol, such as Bluetooth Low Energy (BLE) or infrared (IR). The first signal can indicate the bed-mounted device is present and available for pairing. The room-located device can continuously scans its environment for such signals to detect when a new bed-mounted device has been brought into the room.

At step 704, in response to receiving the first signal, the room-located device may transmit a pairing request to the healthcare bed-mounted device. This request can be sent using the first communication protocol by which the first signal was received, or with another communication protocol. The pairing request can serve to initiate the establishment of a secure wireless connection between the two devices. At this point, the room-located device may also perform authentication procedures to ensure that the bed-mounted device is authorized to connect, thereby maintaining the security of the healthcare facility's communication network.

Upon transmitting the pairing request at step 704, at step 706, the room-located device may engage in a handshake protocol with the bed-mounted device to establish a wireless connection. This could involve both devices exchanging necessary credentials, agreeing on encryption keys, and setting up communication channels that are secure and compliant with healthcare data protection regulations. Once the handshake is successfully completed, a wireless link may be established, allowing for bidirectional communication between the room-located device and the bed-mounted device.

After establishing the wireless connection at step 706, at step 708, the room-located device may receive a third signals from the bed-mounted device. The third signal can be received from the healthcare bed-mounted device using a second communication protocol, which might differ from the first communication protocol to provide redundancy and enhance reliability. For example, if the first communication protocol was BLE, the second communication protocol might be IR or a wired protocol utilizing a 37 pin connector. The third signal may contain critical information regarding patient care events, such as a nurse call activation or a bed exit alarm initiated by the patient interacting with the bed controls.

At step 710, the room-located device may connect and transmit data to a healthcare backend system (healthcare backend system 108). Upon receiving the third signal, the room-located device can process the information from the third signal and transmit the processed information to the healthcare backend system. This can involve formatting the data appropriately and sending it through a wired connection, such as a standard 37-pin connector, to the existing nurse call system or another system. In certain embodiments, the nurse call system or another system triggers alerts, updates patient records, and/or presents notifications, thereby facilitating appropriate responses to patient events.

The following paragraphs include an exemplary scenario showing the integration of the protocol described in FIGS. 6 and 7 with specific device features shown in FIGS. 2-5. When the healthcare facility bed (e.g., healthcare facility bed 102 described above), is rolled into the room, a bed device (e.g., the bed device 104 described above) periodically transmits a Bluetooth address, such as a Bluetooth Low Energy (BLE) address, indicating its availability to pair. This transmission can be conducted using an infrared (IR) signal via the bed device transceiver 208. The message effectively states, “I am available to pair.” When the healthcare room-located device (e.g., the room-located device 106 described above), which currently has no other bed associated with it, receives this IR signal through its healthcare room-located device transceiver 404, it captures the advertised address and initiates the pairing process. The healthcare room-located device 106 establishes a BLE connection between itself and the bed device. Prior to the bed device connecting, an LED indicator, such as the first light indicator 406 on the healthcare room-located device, may display red to signify that it is unpaired and unconnected. In certain embodiments, the bed device advertises an IR address specifically for establishing a Bluetooth connection, utilizing the IR sensor as a line-of-sight communication channel.

Upon successful pairing, the LED indication on the healthcare room-located device 106, specifically the first light indicator 406, may automatically change from red (unpaired) to green (paired). This immediate visual feedback informs the staff that the wireless bed communication system is active. From this point forward, until the bed is moved out of the BLE range (e.g., 25 feet), the bed device and the healthcare room-located device remain paired, similar to the connection between a headset and a phone. During this paired state, both devices are configured to communicate exclusively with each other and do not listen to other devices, such as a second bed that may be rolled into the room.

If the nurse button on the bed rail is pressed by a patient, this action generates a signal that is transmitted to the bed device. The bed device then sends both an IR signal and a BLE message to the healthcare room-located device, indicating that a nurse call has been initiated. Transmitting the signal via both protocols provides redundancy, enhancing the reliability of the communication. This nurse call signal functions similarly to a momentary contact closure, akin to pressing a doorbell.

The healthcare room-located device receives the nurse call message through its healthcare room-located device transceiver 404. In response, it closes a contact on a 37-pin cable connected to its first connector 412 or second connector 414, which is linked to a wall jack and ultimately to the nurse call system. This action effectively places a nurse call on the nurse call system, alerting healthcare staff to the patient's request.

Additionally, if a bed exit event occurs, such as when a bed exit alarm or priority alarm is initiated from the bed, the bed device sends both an IR and a BLE message to the healthcare room-located device. This bed exit feature is typically set on individual beds and activates when a patient begins to exit the bed unassisted. Upon receiving this message, the healthcare room-located device closes a contact on the 37-pin cable to the wall jack and ultimately to the nurse call system. This contact closure represents a latched call from the bed, and it remains closed until the bed exit alarm is cleared by user input on the bed itself, at which point the contact is released, and normal operation resumes.

In the idle state, when there is no nurse call or bed exit activity from the bed, the bed device can periodically send a keep-alive or heartbeat signal to the healthcare room-located device. As an example, the period may be a 60 second period and can serve to inform the healthcare room-located device to maintain the established connection. The keep-alive signal may be sent using both IR and BLE protocols for redundancy, or it may utilize one of the protocols, such as BLE.

If the bed is removed from the room, the bed device and the healthcare room-located device can be manually unpaired by pressing an unpair button, such as the third button 410 or the fourth button 512 on the healthcare room-located device. This action can provide feedback, as the LED indicator, specifically the first light indicator 406, will change from green (paired and connected) to red (unpaired and unconnected), indicating that the devices are no longer connected.

Conversely, if the bed is simply removed from the room, range, and/or line of sight without manual unpairing, the devices may automatically unpair after the bed device moves out of the BLE communication range of the healthcare room-located device 106, which may be approximately 25 feet. If the healthcare room-located device does not receive the next expected heartbeat signal from the bed device, it will recognize that the bed device is no longer in range. The LED indicator on the healthcare room-located device will then transition from green (paired and connected) to red (unpaired and unconnected), reflecting the change in connection status.

In certain embodiments, the absence of the heartbeat signal, indicating that the healthcare room-located device has not received the periodic keep-alive message from the bed device, can be configured to trigger a cord-out call into the nurse call system. This feature acts as an additional safety measure by alerting staff that the bed is no longer connected to the room's communication system, which may require immediate attention.

FIG. 8 illustrates a perspective view of a cable extender 800, according to certain embodiments of the present disclosure and FIG. 9 illustrates an alternative perspective view of a cable extender 800, according to certain embodiments of the present disclosure. The cable extender 800 may be designed to enhance connectivity and accessibility within the healthcare communication system described in the patent application. The cable 806, which serves as a connection to the existing wall jack or nurse call system, may be located at the bottom of the cable extender 800 (or elsewhere on the cable extender 800). This cable can allow the cable extender 800 to interface seamlessly with the healthcare facility's backend systems, transmitting and receiving signals as required.

On the front of the cable extender 800 is the front connector 804. This connector, which may be a 37-pin connector or another suitable type, provides a readily accessible interface for connecting devices such as the bed-mounted device or other peripherals. By situating the front connector 804 on the front face of the extender, it allows healthcare staff to easily plug in devices without having to reach behind equipment or navigate tight spaces, thereby improving efficiency and reducing the risk of disconnection or damage to cables. However, in certain embodiments, the front connector 804 may be located elsewhere on the cable extender 800.

The side connector 902 is located on one side of the cable extender 800. Similar to the front connector 804, the side connector 902 offers additional connectivity options, enabling the connection of multiple devices simultaneously. This is particularly useful in scenarios where multiple monitoring devices or communication systems need to be integrated within the same patient room. The placement of the side connector 902 allows for flexible cable management and easy access for maintenance or reconfiguration. However, in certain embodiments, the side connector 902 may be located elsewhere on the cable extender 800.

The cable extender 800 may include input/output jacks: the bottom I/O jack 814, the middle I/O jack 812, and the top I/O jack 810. The jacks may be placed elsewhere on the cable extender 800. These jacks can accommodate additional peripherals or sensors (e.g., inputs and/or outputs to the cable extender 800), such as external alarm units, patient monitoring devices, or chair exit alarms. By providing multiple I/O jacks, the extender can allow for the consolidation of various inputs into the nurse call system, streamlining the communication infrastructure within the patient room.

A fastener 808 of the cable extender 800 may provide a means to secure cables connected to the I/O jacks or connectors, ensuring that connections remain stable and reducing the risk of accidental disconnection due to movement or tension on the cables. The fastener 808 may also be used to couple the cable extender 800 to the wall, or another object or structure in the healthcare facility.

The components of the cable extender 800 can be designed to enhance the techniques described herein, improving connectivity, accessibility, and/or reliability of the communication system. The cable 806 can enable a secure and direct connection to other systems (e.g., the healthcare backend system 108), facilitating the transmission of critical alerts and data. The front connector 804 and side connector 902 expand the number of devices that can be connected, allowing for greater flexibility in system configuration and the integration of additional monitoring equipment.

A light bar 904 of the cable extender 800 may present visual indications, providing real-time status updates through illumination. For instance, it can display different colors or blink patterns to signify connectivity statuses such as whether devices are properly connected, if there is an active nurse call, or if there is a system alert that requires attention.

The light bar 904 may play a role in providing immediate visual feedback to healthcare staff, enabling quick assessments of system status and prompt responses to patient needs. The I/O jacks 810, 812, and 814 allow for the connection of supplementary devices, enhancing the system's capabilities and adaptability to various patient care scenarios. By incorporating these features in certain embodiments, the cable extender 800 can support the reliable operation of the wireless communication system, so that vital patient information is effectively communicated to healthcare providers.

The cable extender 800 can serves multiple important functions within the overall communication system. Firstly, the cable extender 800 can elevate the wired connection point for the bed to a higher position on the wall, making it more accessible for nurses to plug in easily. In some installations, wall jacks are positioned close to the floor and are often hidden behind the bed, which can lead to difficulties in access and increased risk of beds damaging the cables. By relocating the connection point higher on the wall, the cable extender 800 can mitigate these issues. As depicted in the renderings, the cable 806 extending from the bottom of the cable extender 800 is intended to connect directly to the existing wall jack.

Additionally, the cable extender 800 may facilitate the connection of wireless bed systems by providing a means to ‘patch’ healthcare room-located devices into the standard wall jack. This may be achieved through the front connector 804, which can be a DB37 connector situated on the front of the extender. It allows wireless wall receivers or similar devices to interface seamlessly with the existing infrastructure by connecting through the extender to the standard wall jack.

Furthermore, the cable extender 800 can be equipped with quarter-inch jacks for remote alarm units, such as a chair exit alarm. These devices may function by creating a closed contact when an alarm is triggered. Specifically, the top I/O jack 810 may be wired in parallel with the bed exit system, accommodating devices like chair alarms. The bottom I/O jack 814 can be wired in parallel with the nurse call feature from the bed's side rail, which can be used for medical device alarms such as IV drip alarms or pulse oximeters. This configuration can allow for the integration of additional patient monitoring devices into the nurse call system without the need for extensive rewiring.

The cable extender 800 may provide visual indication of the bed's connection status through the light bar 904 located at the top of the unit. The light bar 904 may illuminate green when the bed cable is properly plugged in and red when the bed cable is not connected. In some embodiments, since there is no power available from the wall jack for the light bar 904, an external power supply, such as the HMNP-1365 power supply, may be required to operate the light bar.

The front connector 804 and side connector 902, both DB37 connectors, can be configured so that right-angle mating connectors will face downward. This orientation can assist in having the cables not interfere with each other. The bottom DB37 connector can be positioned so that if a right-angle cable is used, it will exit to the right side, preventing interference with the cable connected to the front connector.

All three DB37 connectors including the front connector 804, side connector 902, and a bottom connector connected to cable 806 can be wired in parallel, with pins 1 through 37 connected in parallel correspondingly across each connector. However, an exception can be made for a subset of the pins (e.g., pins 8 and 9). For example, on the front connector 804, pins 8 and 9 may serve as inputs that inform the circuitry when the bed cable is plugged in. In certain embodiments, pin 8 shorts to pin 9 when the bed cable (and bed) is connected, and they are open when there is no bed cable connected. This input can be used to drive the green and red illumination of the light bar 904, indicating the connection status.

The top I/O jack 810 may be wired with the tip connected to pin 30 (Priority+) and the ring connected to pin 31 (Priority−). In certain embodiments, the locking mechanism is not wired, as a cord-out call is not desired in this configuration. Similarly, the bottom I/O jack 814 is wired with the tip connected to pin 25 (Nurse Call+) and the ring connected to pin 26 (Nurse Call−), again without wiring the locking mechanism to avoid unintended cord-out calls.

Power is required to illuminate the light bar 904 on the top of the cable extender 800. in certain embodiments, the power supply is optional; if illumination is not required, the power supply can be omitted. When used, the power supply may be an HMNP-1365 or an equivalent device, and may connect via a barrel jack located beneath the two quarter-inch I/O jacks. The estimated power consumption of the LEDs is less than 1 watt, ensuring energy efficiency.

The illumination of the light bar 904 can illuminate an area and/or surface around the cable extender 800 to provide a visual indication. In certain embodiments, the illumination of the light bar 904 can illuminate a light up on a side of the extender, such as to illuminate a wall, a floor, a celling, etc. A first color of light (e.g., green light) may signify that the bed cable is connected, while a second color (e.g., red) light indicates that the bed cable is not connected. In some embodiments, a light is on for a first period of time and off for a second period of time. The first period may be the same or different from the second period of time. In certain embodiments, a light of the cable extender 800 may flash at a rate of one second on and one second off when the bed cable is not connected, although this may be adjusted based on preference and practicality. Implementing this detection and LED driver functionality may require a small microprocessor within the circuitry. LEDs can be mounted either on the top edge of the printed circuit board, aligning with a window, or a small LED strip may be used. In alternative embodiments, any color can be used and can be on any side of the printed circuit board.

In some embodiments, the cable extender 800 can include a dummy plug 816, facilitated by a 6-32 insert for mounting a dummy front release (DFR) dummy plug on the front panel. In some nurse call systems, removing the bed cable generates a call that can be reset at the nurse call station without requiring a dummy plug 816. However, in systems where the cable must be replaced or a dummy plug 816 is necessary to prevent or cancel a cord-out nurse call, the DFR may be required.

In some embodiments, to enhance cable management and reduce strain on the connections, a fastener 808, shown in an exemplary embodiment as a 6-32 insert is provided on the side of the cable extender's case, allowing for the optional attachment of a P-clamp. This clamp can secure the quarter-inch cable(s) in place, minimizing movement and potential disconnection due to tension or accidental pulling.

In certain embodiments, there is flexibility in the system regarding the enabling or disabling of a dummy plug or cord-out alarm. This flexibility permits customization based on the specific requirements of the healthcare facility's nurse call system. For example, if the removal of a bed cable is intended to trigger an alarm, the system can be configured accordingly through the software settings accessible via the data connector 210 or other ports (e.g., a USB-C port) on either the bed device or the room-located device. These configuration features can provide intermediate call routing options that were previously limited to the bed's capabilities. This enhancement allows calls to be routed through different pathways or systems based on predefined criteria, improving communication efficiency. For instance, calls can be directed to specific staff members or departments based on the nature of the alert, patient condition, or staff availability.

In certain embodiments, the healthcare room-located device and the cable extender 800 may include a photosensitive diode. This component can allow for automated control of the light intensity emitted by the room located device's 106 indicators, adjusting brightness in response to ambient light levels to ensure visibility without causing disturbance in dim environments.

Any of the computer systems mentioned herein may utilize any suitable number of subsystems. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

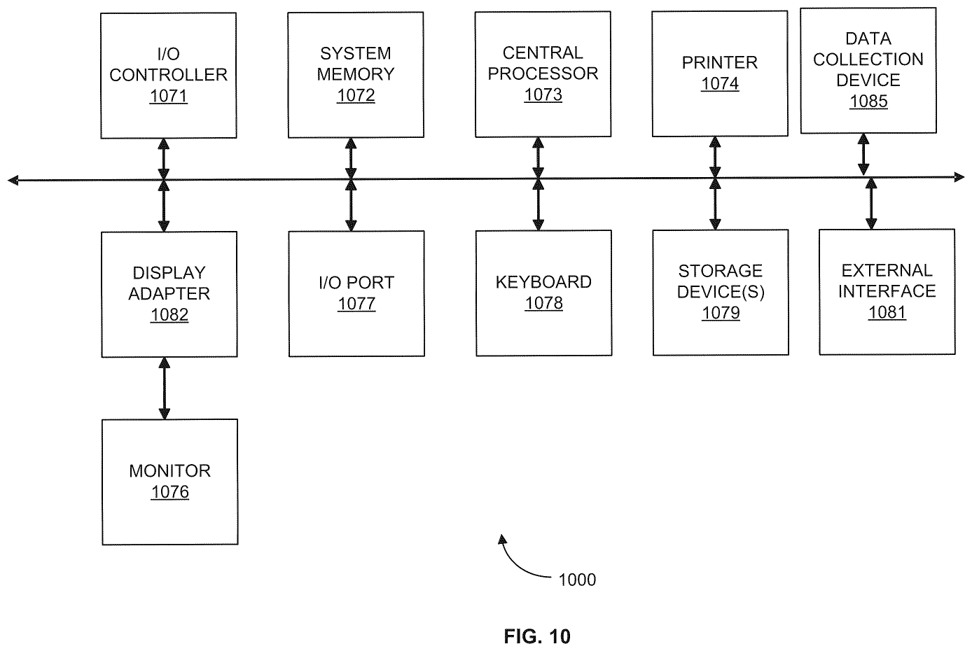

The subsystems shown in FIG. 10 are interconnected via a system bus 1075. Additional subsystems such as a printer 1074, keyboard 1078, storage device(s) 1079, monitor 1076 (e.g., a display screen, such as an LED), which is coupled to display adapter 1082, and others are shown. Peripherals and input/output (I/O) devices, which couple to I/O controller 1071, can be connected to the computer system by any number of means known in the art such as input/output (I/O) port 1077 (e.g., USB, FireWire®). For example, I/O port 1077 or external interface 1081 (e.g. Ethernet, Wi-Fi, etc.) can be used to connect computer system 1010 to a wide area network such as the Internet, a mouse input device, or a scanner. The interconnection via system bus 1075 allows the central processor 1073 to communicate with each subsystem and to control the execution of a plurality of instructions from system memory 1072 or the storage device(s) 1079 (e.g., a fixed disk, such as a hard drive, or optical disk), as well as the exchange of information between subsystems. The system memory 1072 and/or the storage device(s) 1079 may embody a computer readable medium. Another subsystem is a data collection device 1085, such as a camera, microphone, accelerometer, and the like. Any of the data mentioned herein can be output from one component to another component and can be output to the user.

A computer system can include a plurality of the same components or subsystems, e.g., connected together by external interface 1081, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Aspects of embodiments can be implemented in the form of control logic using hardware circuitry (e.g. an application specific integrated circuit or field programmable gate array) and/or using computer software stored in a memory with a generally programmable processor in a modular or integrated manner, and thus a processor can include memory storing software instructions that configure hardware circuitry, as well as an FPGA with configuration instructions or an ASIC. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk) or Blu-ray disk, flash memory, and the like. The computer readable medium may be any combination of such devices. In addition, the order of operations may be re-arranged. A process can be terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

Computer programs typically comprise one or more instructions set at various times in various memory devices of a computing device, which, when read and executed by at least one processor, will cause a computing device to execute functions involving the disclosed techniques. In some embodiments, a carrier containing the aforementioned computer program product is provided. The carrier is one of an electronic signal, an optical signal, a radio signal, or a non-transitory computer-readable storage medium.

Any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and (ii) the components of respective embodiments may be combined in any manner.

What is claimed is:

1. A health care facility bed device comprising:
a housing configured to attach to a healthcare facility bed;
one or more storage media storing instructions; and
one or more processors configured to execute the instructions to cause the health care facility bed device to:
transmit a first signal using a first protocol to a healthcare room-located device configured to communicate with a healthcare backend system;
receive a pairing request from the healthcare room-located device that was transmitted responsive to the first signal;
responsive to the pairing request, establish a wireless connection with the healthcare room-located device;
receive a second signal from the healthcare facility bed; and
responsive to receiving the second signal, transmit a third signal using a second protocol to the healthcare room-located device.

2. The health care facility bed device of claim 1, wherein the health care facility bed device receives power from the healthcare facility bed over a power connection and wherein the second signal includes data.

3. The health care facility bed device of claim 1, wherein the first protocol is a light-based protocol and the second protocol is a radio-frequency based protocol.

4. The health care facility bed device of claim 1, wherein the wireless connection is maintained while the health care facility bed device is within a predetermined distance to the healthcare room-located device.

5. The health care facility bed device of claim 1, wherein instructions further cause the health care facility bed device to present an indication based at least in part on the second signal.

6. The health care facility bed device of claim 1, wherein the housing is configured to attach to the healthcare facility bed using at least one of a magnet, a clip, a suction cup, a compression fitting, a hook and loop fastener, or an adhesive.

7. A communication system for a hospital bed, comprising:
a health care facility bed device including:
a first housing configured to attach to a healthcare facility bed;
one or more first storage media storing first instructions; and
one or more second processors configured to execute the first instructions to cause the health care facility bed device to:
transmit a first signal using a first protocol to a healthcare room-located device;
receive a pairing request from the healthcare room-located device that was transmitted responsive to the first signal;
responsive to the pairing request, establish a wireless connection with the healthcare room-located device;
receive a second signal from the healthcare facility bed; and
responsive to receiving the second signal, transmit a third signal using a second protocol to the healthcare room-located device; and
the healthcare room-located device configured to communicate with a healthcare backend system, the healthcare room-located device including:
a second housing configured to attach to a wall of a healthcare facility;
one or more second storage media storing second instructions; and
one or more second processors configured to execute the second instructions to cause the health care facility bed device to:
receive the first signal from the health care facility bed device;
responsive to receiving the first signal, transmit the pairing request to the health care facility bed device;
establish the wireless connection with the health care facility bed device;
receive the third signal from the health care facility bed device using the second protocol; and
an interface configured to connect to the healthcare backend system.

8. The communication system of claim 7, wherein the first protocol is an infrared protocol and the second protocol is a Bluetooth protocol.

9. The communication system of claim 8, wherein the first housing further comprises an external infrared transceiver.

10. The communication system of claim 7, wherein the health care facility bed device and the healthcare room-located device are within a line of sight to one another and a predetermined distance to one another.

11. The communication system of claim 10, wherein the wireless connection is maintained while the health care facility bed device is within the predetermined distance to the healthcare room-located device.

12. The communication system of claim 10, wherein the third signal includes data from the second signal.

13. A method performed by a health care facility bed device, the method comprising:
transmitting a first signal using a first protocol to a healthcare room-located device configured to communicate with a healthcare backend system;
receiving a pairing request from the healthcare room-located device that was transmitted responsive to the first signal;
responsive to the pairing request, establishing a wireless connection with the healthcare room-located device;
receiving a second signal from a healthcare facility bed; and
responsive to receiving the second signal, transmitting a third signal using a second protocol to the healthcare room-located device.

14. The method of claim 13, wherein the first protocol is an infrared protocol, and the second protocol is a Bluetooth protocol.

15. The method of claim 13, wherein the third signal includes at least one of a battery status, a status of the wireless connection, or a physical connection status.

16. The method of claim 13, the method further comprising receiving a second pairing request from a user interface before transmitting the first signal.

17. The method of claim 13, presenting an indication based at least in part on the second signal.

18. The method of claim 13, wherein the health care facility bed device and the healthcare room-located device are within a line of sight to one another and a predetermined distance to one another.

19. The method of claim 18, wherein the wireless connection is maintained while the health care facility bed device is within the predetermined distance to the healthcare room-located device.

20. The method of claim 13, wherein the first signal includes a broadcast signal that is periodically transmitted.
